(19) United States
(12) Patent Application Publication
(10) Pub. No.: US 2016/0051940 A1
(43) Pub. Date: Feb. 25, 2016

(54) SEPARATION MEMBRANE FOR SEAWATER DESALINATION AND METHOD FOR PRODUCING SAME

(71) Applicants: KOREA WATER RESOURCES CORPORATION, Daejeon (KR); IUCF-HYU (INDUSTRY-UNIVERSITY COOPERATION FOUNDATION HANYANG UNIVERSITY, Seoul (KR); INDUSTRY- ACADEMIC COOPERATION FOUNDATION OF KYUNGNAM UNIVERSITY, Gyeongsangnam-do (KR)

(72) Inventors: Ho Bum PARK, Seoul (KR); Hyo Won KIM, Seoul (KR); Hee Dae LEE, Seoul (KR); Sang-Seek BAE, Seoul (KR); Seung Hyun KIM, Gyeongsangnam-do (KR); Geung Jeon HAN, Gyeonggi-do (KR); Sang Cheol LEE, Daejeon (KR)

(73) Assignees: KOREA WATER RESOURCES CORPORATION, Daejeon (KR); IUCF-HYU (INDUSTRY-UNIVERSITY COOPERATION FOUNDATION HANYANG UNIVERSITY, Seoul (KR); INDUSTRY-ACADEMIC COOPERATION FOUNDATION OF KYUNGNAM UNIVERSITY, Gyeongsangnam-do (KR)

(21) Appl. No.: 14/783,299

(22) PCT Filed: Mar. 31, 2014
(86) PCT No.: PCT/KR2014/002722

§ 371 Date: Oct. 8, 2015

(30) Foreign Application Priority Data
Apr. 8, 2013 (KR) 10-2013-0038195

(51) Int. Cl. B01D 69/14; B01D 61/02; B01D 71/02; B01D 69/12; B01D 71/56; B01D 71/60; C02F 1/44; B01D 67/00

(52) U.S. Cl. CPC B01D 69/148; C02F 1/441; B01D 61/025; B01D 67/0006; B01D 69/125; B01D 71/56; B01D 71/60; B01D 71/021; C02F 2103/08

(57) ABSTRACT

Provided is a separation membrane for seawater desalination and a method for manufacturing the same, and more particularly, a separation membrane for seawater desalination with excellent water permeability and salt rejection and a method for manufacturing the same. If the separation membrane for seawater desalination and the method for manufacturing the same according to the present disclosure are applied, it is possible to provide a separation membrane for seawater desalination with excellent water permeability and salt rejection. Therefore, it is possible to provide a separation membrane for seawater desalination with improved performance in comparison to an existing separation membrane for seawater desalination. As a result, water resources may be widely utilized.

### TECHNICAL FIELD

The present disclosure relates to a separation membrane for seawater desalination and a method for manufacturing the same, and more particularly, to a separation membrane for seawater desalination with excellent water permeability and salt rejection and a method for manufacturing the same.

### BACKGROUND ART

A separation membrane for seawater desalination (a reverse osmosis membrane) is efficiently utilized for producing water for domestic and industrial use by separating water in a molecule level and removing salts. In the separation membrane for seawater desalination, important factors dominating the performance are water permeability and salt rejection of the separation membrane for seawater desalination.

Among them, it is being actively studied to apply rapid water permeation performance in a carbon nano tube to the separation membrane for seawater desalination. However, in the existing study on the carbon nano tube-polymer composite separation membrane, the composite separation membrane is fabricated without preprocessing the carbon nano tube to improve the water permeation performance, but salt rejection tends to decrease.

In addition, if a general carbon nano tube is applied, agglomeration occurs in a surfactant while the separation membrane is produced, which disturbs dispersion.

In order to solve the above problems, Korean Patent Registration No. 10-1123859 (Patent Literature 1) has proposed a reverse osmosis membrane in which a carbon nano tube is inserted and its manufacturing method, where a carbon nano tube is inserted when making the reverse osmosis membrane to improve chlorine resistance of an active layer of the reverse osmosis membrane.

In addition, Korean Unexamined Patent Publication No. 10-2011-0098503 (Patent Literature 2) has proposed a polyamide reverse osmosis membrane with improved chlorine resistance and a method for manufacturing the same, in which a carbon nano tube is introduced to a polyamide reverse osmosis membrane active layer using interfacial polymerization to improve chlorine resistance, wherein a carbon nano tube is dispersed in a polar solvent to reinforce chlorine resistance of the reverse osmosis membrane active layer. Even though there have been many attempts to facilitate easy dispersion while including a carbon nano tube as in Patent Literatures 1 and 2, there still remains a problem of deteriorated dispersibility caused by low salt rejection and agglomeration.

### RELATED LITERATURES

Patent Literature 1: Korean Patent Registration No. 10-1123859

Patent Literature 2: Korean Unexamined Patent Publication No. 10-2011-0098503

### DISCLOSURE

### Technical Problem

The present disclosure is directed to providing a separation membrane for seawater desalination and a method for manufacturing the same, which has excellent water permeability and non-deteriorated salt rejection.

### Technical Solution

In one general aspect, the present disclosure provides a separation membrane for seawater desalination, which includes a carbon nano tube having an open terminal and coated with dopamine.

In addition, the carbon nano tube may have an average length of 1 to 2 μm and an average diameter of 5 to 8 nm.

In addition, when the carbon nano tube with an open terminal is analyzed by means of atomic absorption spectrometry, binding energy caused by bonding carbon and oxygen may have a peak in 288 to 290 eV.

In another aspect of the present disclosure, there is provided a method for manufacturing a separation membrane for seawater desalination, which includes the steps of:

1) obtaining a carbon nano tube with an open terminal by means of thermal oxidation;

2) coating carbon nano tube with an open terminal obtained in Step 1) with dopamine; and

3) dispersing the carbon nano tube obtained in Step 2) in an amine solution and performing interfacial polymerization to make a carbon nano tube-polyamide composite separation membrane.

In addition, the thermal oxidation of Step 1) may be performed by:

oxidizing the carbon nano tube at 800 to 1000° C. for 1 to 3 hours while injecting inert gas thereto, then

cooling the carbon nano tube at normal temperature to have a temperature of 25 to 40° C., then

heating the carbon nano tube to a temperature of 300 to 600° C. and keeping the carbon nano tube at the temperature for 2 to 4 hours, and then

injecting inert gas thereto to cool the carbon nano tube to normal temperature.

In addition, when the carbon nano tube with an open terminal is coated in Step 2), the dopamine may be used in amount of 1,000 parts by weight, based on 100 parts by weight of the carbon nano tube with an open terminal.

In addition, the amine solution may contain at least one amine selected from the group consisting of ortho-phenylene diamine, meta-phenylene diamine, para-phenylene diamine, piperazine, ethylene diamine, cadaverine, and their mixtures.

### Advantageous Effects

If the separation membrane for seawater desalination and the method for manufacturing the same according to the present disclosure are applied, it is possible to provide a separation membrane for seawater desalination with excellent water permeability and salt rejection.

In addition, since dispersibility of a carbon nano tube is improved while the separation membrane is fabricated, it is possible to provide a separation membrane for seawater desalination with improved performance.

### DESCRIPTION OF DRAWINGS

FIG. 1 is a photograph showing dispersion results according to Preparation Example 2 and a diagram showing analysis results of a UV spectrometer.

FIG. 2 is a photograph showing dispersion results of a case where dopamine is not coated, and a diagram showing analysis results of a UV spectrometer.

FIG. 3 is a photograph showing a carbon nano tube with an open terminal, treated with thermal oxidation according to Example 1.

FIG. 4 is a photograph showing a carbon nano tube whose terminal is not opened since thermal oxidation treatment is not performed according to Comparative Example 1.

FIG. 5 is a graph showing water permeability of a separation membrane prepared according to Comparative Example 1.

FIG. 6 is a graph showing water permeability of a separation membrane prepared according to Comparative Example 3.

FIG. 7 shows a result of thermo gravimetric analysis (TGA) of a carbon nano tube depending on whether thermal oxidation treatment is performed or not.

FIG. 8 is a graph showing a peak varying in an atomic absorption spectrometry due to thermal oxidation treatment.

FIG. 9 is a transmission electron microscope (TEM) image showing a carbon nano tube coated with dopamine.

FIG. 10 is a diagram for illustrating a method for manufacturing a carbon nano tube-polyamide composite separation membrane according to Example 1 of the present disclosure.

### BEST MODE

The inventors have studied to develop a separation membrane for seawater desalination with excellent water permeability and excellent salt rejection as well as a method for manufacturing the same, and as a result found and completed a separation membrane for seawater desalination and a method for manufacturing the same according to the present disclosure.

Generally, a separation membrane for seawater desalination (a reverse osmosis membrane) separates seawater into water and salts so that the seawater may be used as water for general purpose. Therefore, the separation membrane may ensure excellent performance only when water permeability and salt rejection are excellent.

Meanwhile, a support layer is coupled to the separation membrane, and the support layer supports the separation membrane. Also, the support layer generally has a thickness of 100 to 200 μm, the separation membrane generally has a thickness of 100 to 120 μm.

In addition, thermal oxidation represents an oxidizing method by applying high-temperature heat.

In detail, the separation membrane for seawater desalination according to the present disclosure includes a carbon nano tube coated with dopamine.

The dopamine is one of biomimetic materials and found in mussel extracts. The dopamine causes spontaneous absorption reactions to various materials under specific conditions, and has a hydroxyl group (—OH) and an amine function group (—NH₂) to improve hydrophilic property of the absorbed material.

Since the carbon nano tube is coated with dopamine, in the solution used for manufacturing the separation membrane for seawater desalination, the carbon nano tube has improved dispersibility.

A separation membrane for seawater desalination according to another embodiment of the present disclosure includes a carbon nano tube having an open terminal and coated with dopamine. Here, the carbon nano tube has an average length of 1 to 2 μm and an average diameter of 5 to 8 nm.

In particular, the terminal of the carbon nano tube may be opened by treating the carbon nano tube with thermal oxidation.

If the thermal oxidation treatment is performed to open the terminal of the carbon nano tube, the average length, which is 3 to 5 μm when the terminal is closed before the treatment, decreases to 1 to 2 μm after the carbon nano tube is treated. In addition, if the thermal oxidation treatment is performed to open the terminal of the carbon nano tube, the average diameter, which is 6 to 10 nm before the treatment, decreases to 5 to 8 nm after the carbon nano tube is treated.

If the carbon nano tube with an open terminal has an average length smaller than 1 μm, it is not expected that the water permeation performance is improved through the inside of the carbon nano tube in the selection layer due to too short length. In addition, if the carbon nano tube with an open terminal has a length greater than 2 μm, protrusions may be generated at the selection layer due to too long length.

If the carbon nano tube with an open terminal has a smaller average diameter, performance is generally further improved. However, if the average diameter is smaller than 5 nm, water permeability deteriorates too much. Also, if the average diameter is greater than 8 nm, the salt rejection aimed by the present disclosure deteriorates too much.

In addition, by coating the carbon nano tube with the dopamine, the carbon nano tube has improved dispersibility in a solution used for manufacturing the separation membrane for seawater desalination.

Meanwhile, when the terminal of the carbon nano tube is opened by means of the thermal oxidation, oxygen increases in the carbon nano tube, which leads to increased bonding of carbon and oxygen.

Therefore, if the carbon nano tube with an open terminal is analyzed by means of atomic absorption spectrometry, binding energy caused by bonding carbon and oxygen has a peak in 288 to 290 eV. If the carbon nano tube is analyzed by means of atomic absorption spectrometry before thermal oxidation treatment is performed, a distinctive peak is not found in 288 to 290 eV, different from the case where thermal oxidation treatment is performed.

The selection layer for the seawater desalination reverse osmosis membrane according to the present disclosure, which has the above characteristics, has excellent water permeability and salt rejection, which allows the seawater desalination reverse osmosis membrane to have excellent performance.

A method for manufacturing a separation membrane for seawater desalination according to another embodiment of the present disclosure includes the following steps:

1) obtaining a carbon nano tube with an open terminal by means of thermal oxidation;

2) coating carbon nano tube with an open terminal obtained in Step 1) with dopamine; and

3) dispersing the carbon nano tube obtained in Step 2) in an amine solution and performing interfacial polymerization to make a carbon nano tube-polyamide composite separation membrane.

First, a terminal of the carbon nano tube is opened by means of the thermal oxidation of Step 1).

The thermal oxidation is not specially limited as long as the terminal is opened while the carbon nano tube is oxidized by injecting heat thereto. However, the thermal oxidation may be performed by oxidizing the carbon nano tube at 800 to 1000° C. for 1 to 3 hours while injecting inert gas thereto, then cooling the carbon nano tube at normal temperature to have a temperature of 25 to 40° C., then heating the carbon nano tube to a temperature of 300 to 600° C. and keeping the carbon nano tube at the temperature for 2 to 4 hours, and then injecting inert gas thereto to cool the carbon nano tube to normal temperature. By means of the thermal oxidation, the terminal of the carbon nano tube is opened. If the separation membrane for seawater desalination including the carbon nano tube with an open terminal is manufactured, rapid water permeation into the carbon nano tube may be allowed, and in comparison to the case before the terminal is opened, it is possible to provide a separation membrane for seawater desalination with excellent water permeability. In addition, if the terminal of the carbon nano tube is opened by means of the thermal oxidation, the average diameter of the carbon nano tube decrease to 5 to 8 nm, and thus an influence caused by the decrease of salt rejection at the active layer may be reduced. In addition, if the terminal of the carbon nano tube is opened by means of the thermal oxidation, the carbon nano tube has an average length of 1 to 2 μm, and thus the carbon nano tube may be perfectly enclosed in the separation membrane without any protrusion, thereby preventing deterioration of water permeability.

In Step 2), the carbon nano tube is coated with dopamine, which may improve dispersibility of the carbon nano tube in a solution used for manufacturing the separation membrane. In general cases, a surfactant is generally put into the solution used for manufacturing the separation membrane in order to improve dispersibility of the carbon nano tube. However, even though such a surfactant is put, dispersibility of the carbon nano tube may deteriorate, which results in agglomeration. However, in the present disclosure, since the carbon nano tube is coated with dopamine, dispersibility of the carbon nano tube is greatly improved.

In addition, in Step 2), when the carbon nano tube with an open terminal is coated, the dopamine is used in amount of 1,000 parts by weight, based on 100 parts by weight of the carbon nano tube with an open terminal.

Next, the carbon nano tube obtained in Step 2) is dispersed in an amine solution, and then interfacial polymerization is performed thereto to make a carbon nano tube-polyamide composite separation membrane. At this time, the carbon nano tube has excellent dispersibility in the amine solution and exhibits very low agglomeration since it is coated with dopamine.

In addition, the amine solution may contain at least one amine selected from the group consisting of ortho-phenylene diamine, meta-phenylene diamine, para-phenylene diamine, piperazine, ethylene diamine, cadaverine, and their mixtures.

### MODE FOR INVENTION

Hereinafter, the present disclosure will be described in detail with reference to examples so that the present disclosure may be easily implemented by those skilled in the art. However, the present disclosure may be implemented in various ways, without being limited to the examples.

### EXAMPLES

### Preparation Example 1

### Preparation of a Carbon Nano Tube with an Open Terminal by Means of Thermal Oxidation Treatment

In order to perform the thermal oxidation treatment, a thermal annealing process was performed first to remove amorphous carbon and impurities. A carbon nano tube was placed in a furnace, and the reaction was performed under the argon atmosphere at 900° C. for 2 hours. Secondarily, in order to open the terminal of the carbon nano tube, a thermal oxidation process was performed. The furnace was filled with high-purity air, and the carbon nano tube was heated under the air condition at a ratio of 10° C. per minute to 400° C. and then maintained isothermally at 400° C. for 3 hours. Then, the internal temperature of the furnace was raised to 500° C. at a ratio of 10° C. per minute and then maintained at 500° C. for 30 minutes. And then, the carbon nano tube was cooled to normal temperature while injecting inert gas (argon) thereto, thereby making a carbon nano tube with an open terminal.

### Preparation Example 2

### Preparation of a Carbon Nano Tube Coated with Dopamine

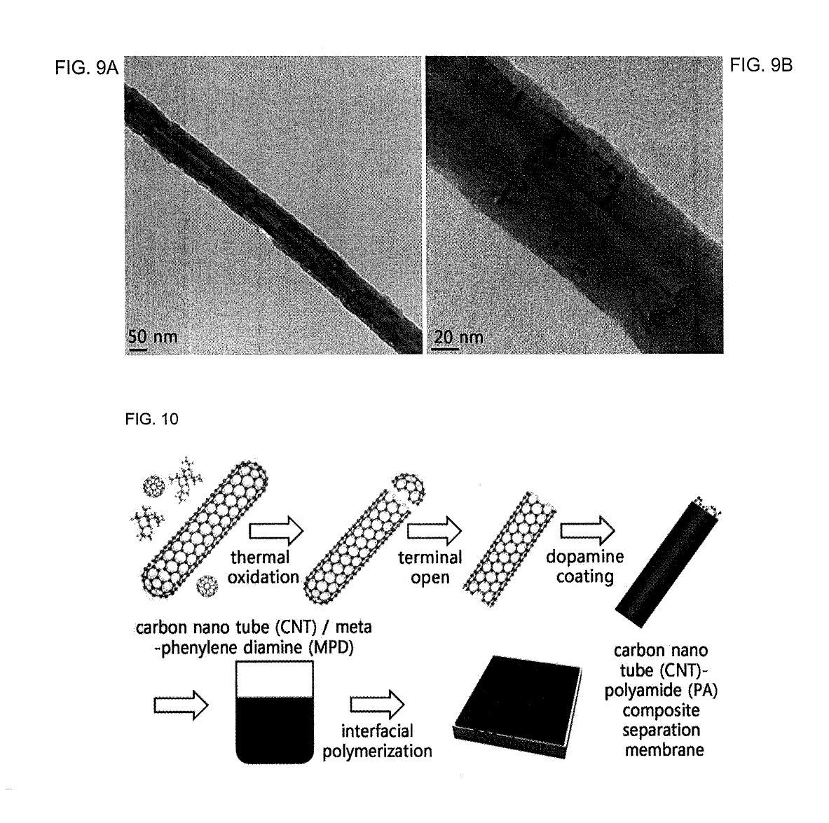

In order to improve dispersibility of the carbon nano tube with an open terminal prepared according to Preparation Example 1, a poly-dopamine coating process was introduced. A dopamine solution (2,000 ppm dopamine hydrochloride), which is as a precursor of poly-dopamine, was prepared under specific conditions (pH was controlled to pH 8.5 or above by using 1 M NaOH to 15 mM Trizma solution), and then reaction was performed together with the carbon nano tube by using a known stirring coating method. In addition, the coating process was performed while reacting by an ultrasonic homogeneous system for uniform coating, and a centrifugal process was performed in order to separate the carbon nano tube uniformly coated with poly-dopamine. FIG. 9 shows TEM analysis results of a structure of the carbon nano tube coated with poly-dopamine.

### Example 1

### Preparation of a Carbon Nano Tube-Polyamide Composite Separation Membrane by Means of Interfacial Polymerization

The carbon nano tube preprocessed according to Preparation Example 1 and coated with dopamine according to Preparation Example 2 was dispersed in a water system together with a surfactant and then stirred with meta-phenylene diamine (MPD) to obtain a MPD solution. Also, trimesoyl chloride (TMC) was dissolved in a dodecane solvent to obtain an organic solution. After then, interfacial polymerization was performed to both solutions to make a terminal-opened carbon nano tube-polyamide composite separation membrane. Also, in order to check dispersion performance, UV/Vis spectroscopic analysis was performed while increasing a concentration of the carbon nano tube.

### COMPARATIVE EXAMPLES

### Comparative Example 1

A carbon nano tube-polyamide composite separation membrane was manufactured in the same way as Example 1, except that the processes of Preparation Example 1 and Preparation Example 2 were not performed.

### Comparative Example 2

A carbon nano tube-polyamide composite separation membrane was manufactured in the same way as Example 1, except that the process of Preparation Example 1 was not performed.

### Comparative Example 3

A carbon nano tube-polyamide composite separation membrane was manufactured in the same way as Example 1, except that the process of Preparation Example 2 was not performed.

### Experimental Examples

### Experimental Example 1

### Measurement of Dispersibility

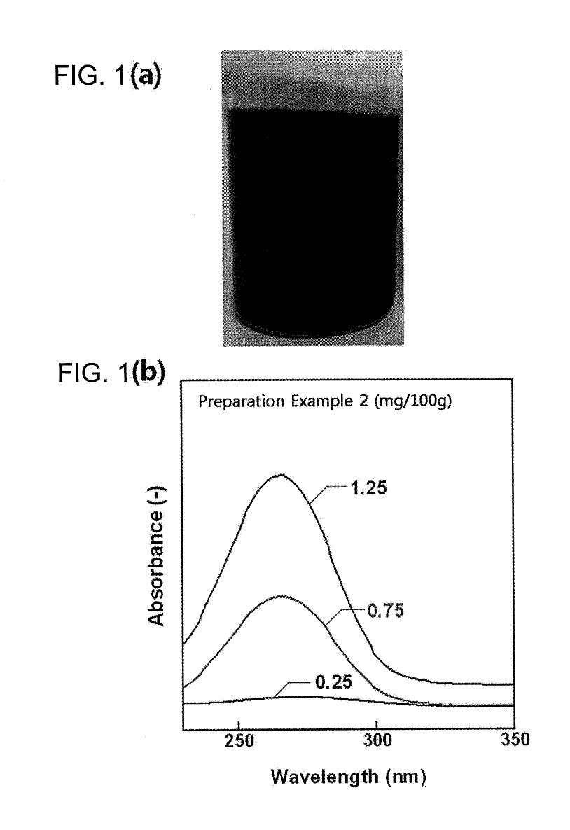

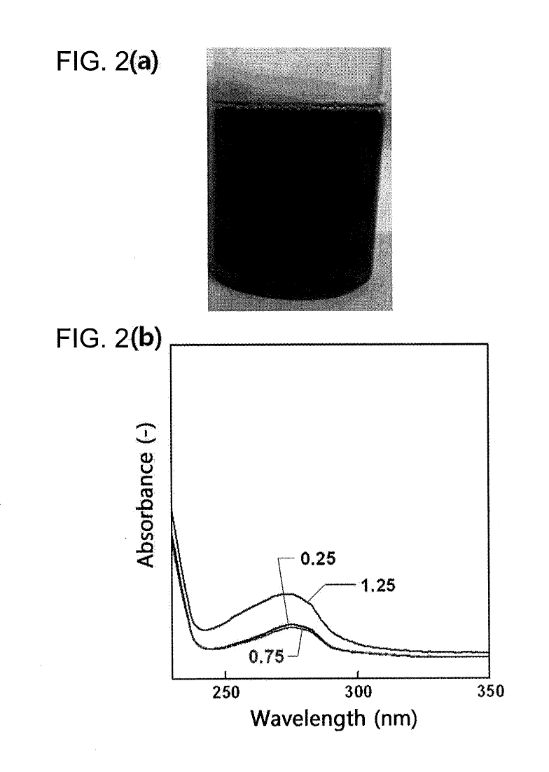

An experiment was performed to measure an influence on dispersibility in a solution depending on whether dopamine was coated or not. This experiment was performed using dispersion of an ultrasonic homogeneous system and analysis of a UV spectrometer (UV/Vis spectroscopy). Its photograph and analysis results of the UV spectrometer are depicted in FIGS. 1 and 2.

As shown in FIG. 1, it can be found that dispersion is performed well in Preparation Example 2 where the carbon nano tube is coated with dopamine (FIG. 1a). In addition, from the UV spectroscopic analysis results, it can be found that dispersion is performed well even though the carbon nano tube has a higher concentration (FIG. 1b).

However, as shown in FIG. 2, it can be found that dispersion is not performed well if the carbon nano tube is not coated with dopamine. In addition, it may be found that if the concentration of the carbon nano tube is higher, dispersion is worse.

### Experimental Example 2

### Measurement on Whether the Terminal of the Carbon Nano Tube is Opened

An experiment was performed to check whether the terminal of the carbon nano tube to which thermal oxidation was performed according to Preparation Example 1 was opened. In this experiment, a TEM photograph was taken, and for comparison, a TEM photograph was also taken for a carbon nano tube to which thermal oxidation was not performed.

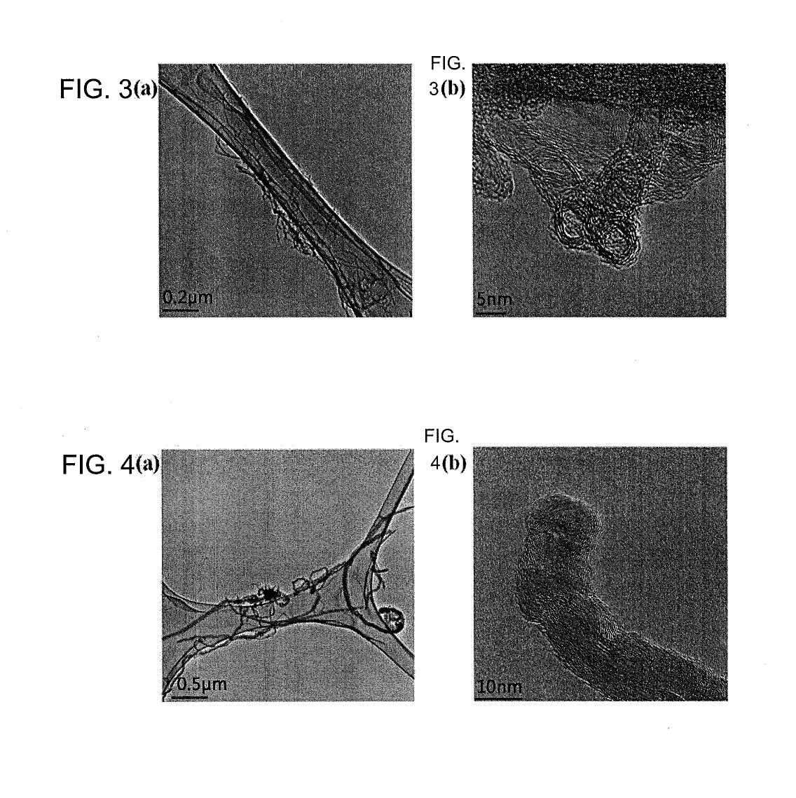

FIG. 3 is a TEM photograph showing the terminal of the carbon nano tube to which thermal oxidation is performed according to Preparation Example 1, and FIG. 4 is a TEM photograph showing the terminal of the carbon nano tube to which thermal oxidation is not performed.

As shown in FIGS. 3 and 4, it can be found that in Preparation Example 1 where thermal oxidation is performed, the terminal of the carbon nano tube is opened, different from Comparative Example 1.

Meanwhile, it can be found that the carbon nano tube having a terminal not opened since thermal oxidation is not performed thereto has an average length of 3 to 5 μm, and the carbon nano tube having an open terminal by performing thermal oxidation has an average length of 1 to 2 μm, and thus it can also be found that the average length of the carbon nano tube decreases as the terminal is opened by thermal oxidation. In addition, it can be found that the carbon nano tube having a terminal not opened since thermal oxidation is not performed thereto has an average diameter of 6 to 10 nm, and the carbon nano tube having an open terminal by performing thermal oxidation has an average diameter of 5 to 8 nm, and thus it can also be found that the average diameter of the carbon nano tube decreases as the terminal is opened by thermal oxidation.

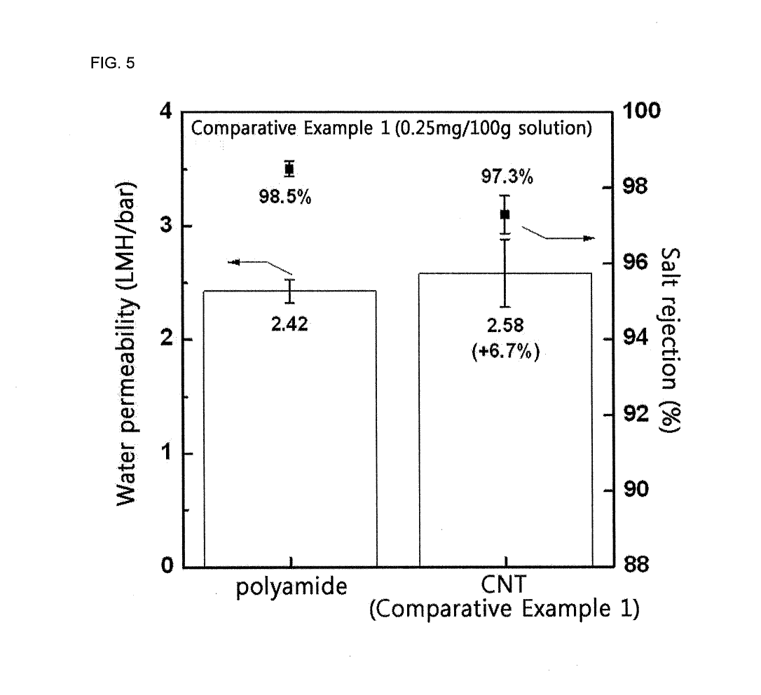

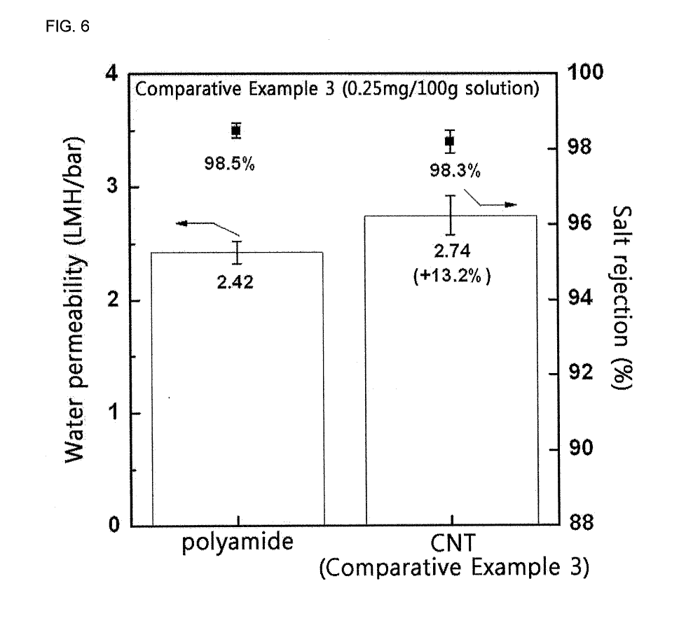

Meanwhile, an experiment was performed to analyze water permeability of separation membranes respectively manufactured using the carbon nano tube with an open terminal and the carbon nano tube with an unopened terminal. The analysis results are depicted in FIGS. 5 and 6. FIG. 5 shows a case where a carbon nano tube having an unopened terminal and not coated with dopamine according to Comparative Example 1 is used, and FIG. 6 shows a case where a carbon nano tube not coated with dopamine but having an open terminal according to Comparative Example 3 is used. As shown in the figures, it can be found that water permeability increases when the carbon nano tube with an open terminal is used, in comparison to the caser where the terminal is not opened.

### Experimental Example 3

### Thermo Gravimetric Analysis (TGA) and Atomic Absorption Spectrometry (AAA) of the Carbon Nano Tube with an Open Terminal

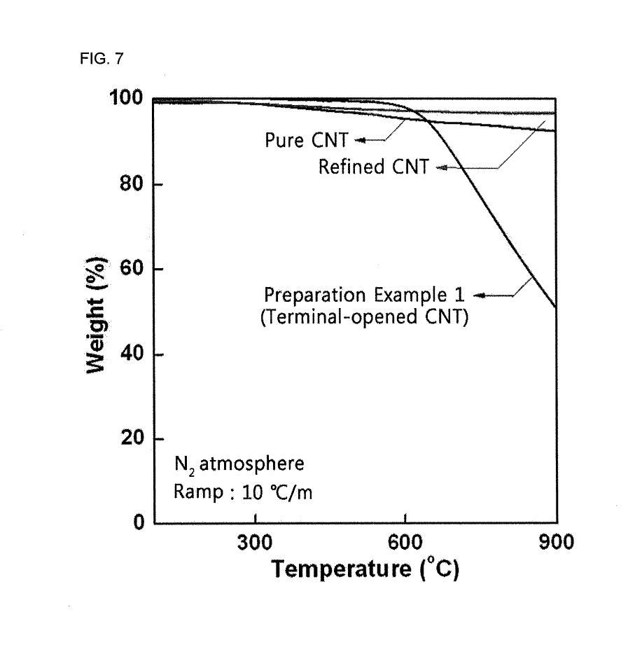

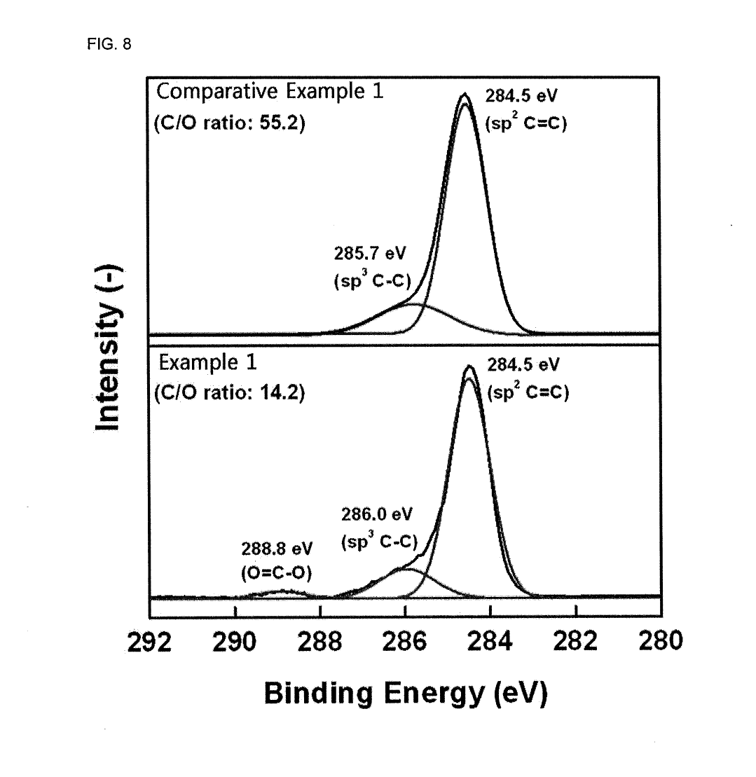

An experiment was performed for thermo gravimetric analysis and atomic absorption spectrometry in order to check structural differences between a carbon nano tube having an open terminal by performing thermal oxidation according to Preparation Example 1 and a carbon nano tube having an unopened terminal by performing no thermal oxidation. The results are depicted in FIGS. 7 and 8.

As shown in FIG. 7, it can be found that the weight of the carbon nano tube increases as the temperature rises, when thermal oxidation is applied according to Preparation Example 1. In addition, as shown in FIG. 8, in case of Preparation Example 1, when the carbon nano tube with an open terminal is analyzed by means of atomic absorption spectrometry, it can be found that binding energy caused by bonding carbon and oxygen has a peak in 288 to 290 eV. However, when thermal oxidation is not applied, a distinctive peak is not found in 288 to 290 eV. This may be analyzed in a way that, in case of Preparation Example 1, a distinctive peak is shown in 288 to 290 eV since the number of oxygen atoms generated at the terminal through thermal oxidation increases so that bonds of carbon and oxygen increase.

### Experimental Example 4

### Measurement of Water Permeability and Salt Rejection of a Composite Separation Membrane Prepared According to Example 1

An experiment was performed to measure water permeability and salt rejection of separation membranes respectively prepared according to Example 1 and Comparative Example 1. The performance of the separation membrane was measured by using a cross-flow filtration system. For the performance evaluation, a NaCl solution with a concentration of 2,000 ppm was fed, and operation conditions such as a flow rate of 2 LPM, pressure of 15.5 bar and temperature of 25° C. were used. Water permeability was measured with a program using an electronic scale connected to the membrane, and salt rejection was measured using an ion conductivity meter. Table 1 below shows measurement results of water permeability and salt rejection of a general polyamide separation membrane (PA), a separation membrane containing 0.25 mg of carbon nano tube according to Comparative Example 1, and a separation membrane containing 0.25 mg of carbon nano tube according to Comparative Example 3. In addition, Table 2 below shows measurement results of water permeability and salt rejection of the separation membrane prepared according to Example 1, which are measured as increasing the content of the carbon nano tube. In addition, Table 3 below shows measurement results of water permeability and salt rejection of the separation membrane prepared according to Comparative Example 3.

TABLE 1

| Separation membrane | Water permeability | Salt rejection |
|---|---|---|
| (content of carbon nano tube) | (LMH/bar) | (%) |
| Polyamide separation | 2.42 ± 0.1 | 98.5 ± 0.2 |
| membrane (0) | | |
| Comparative Example 1 (0.25 mg) | 2.58 ± 0.3 | 97.3 ± 0.5 |
| Comparative Example 3 (0.25 mg) | 2.74 ± 0.17 | 98.2 ± 0.3 |

TABLE 2

| Separation membrane | Water permeability | Salt rejection |
|---|---|---|
| (content of carbon nano tube) | (LMH/bar) | (%) |
| Polyamide separation | 2.42 ± 0.1 | 98.7 ± 0.2 |
| membrane (0) | | |
| Example 1 (0.25 mg) | 2.8 ± 0.11 | 98.5 ± 0.15 |
| Example 1 (1.25 mg) | 3.08 ± 0.16 | 98.7 ± 0.12 |
| Example 1 (3.75 mg) | 3.31 ± 0.17 | 98.5 ± 0.2 |

TABLE 3

| Separation membrane | Water permeability | Salt rejection |
|---|---|---|
| (content of carbon nano tube) | (LMH/bar) | (%) |
| Polyamide separation | 2.42 ± 0.1 | 98.5 ± 0.2 |
| membrane (0) | | |
| Comparative Example 3 (0.25 mg) | 2.71 ± 0.17 | 98.2 ± 0.3 |
| Comparative Example 3 (0.75 mg) | 2.39 ± 0.06 | 98.3 ± 0.3 |
| Comparative Example 3 (1.25 mg) | 2.01 ± 0.16 | 97.4 ± 0.7 |

As shown in Table 1, it can be found that if the carbon nano tube with an open terminal is used (Comparative Example 3), water permeability basically increases, in comparison to other cases (Comparative Example 1).

In addition, as shown in Table 2, it can be found that in Example 1 according to the present disclosure, even though the content of the carbon nano tube increases, water permeability and salt rejection are improved or maintained. However, in Table 3, in case of Comparative Example 3, even though the content of the carbon nano tube increases, water permeability is not improved, and rather salt rejection deteriorates. From this, it may be understood that if the carbon nano tube with an open terminal is coated with dopamine, water permeability and salt rejection are improved.

Though preferred embodiments of the present disclosure have been described, the present disclosure is not limited thereto, but various modifications can be made within the scope of the present disclosure, which also belong to the scope of the appended claims.

1. A separation membrane for seawater desalination, comprising:
a carbon nano tube having an open terminal and coated with dopamine.

2. The separation membrane for seawater desalination according to claim 1,
wherein the carbon nano tube has an average length of 1 to 2 μm and an average diameter of 5 to 8 nm.

3. The separation membrane for seawater desalination according to claim 1,
wherein when the carbon nano tube with an open terminal is analyzed by means of atomic absorption spectrometry, binding energy caused by bonding carbon and oxygen has a peak in 288 to 290 eV.

4. A method for manufacturing a separation membrane for seawater desalination, comprising:
1) obtaining a carbon nano tube with an open terminal by means of thermal oxidation;
2) coating carbon nano tube with an open terminal obtained in Step 1) with dopamine; and
3) dispersing the carbon nano tube obtained in Step 2) in an amine solution and performing interfacial polymerization to make a carbon nano tube-polyamide composite separation membrane.

5. The method for manufacturing a separation membrane for seawater desalination according to claim 4,
wherein the thermal oxidation of Step 1) is performed by:
oxidizing the carbon nano tube at 800 to 1000° C. for 1 to 3 hours while injecting inert gas thereto, then
cooling the carbon nano tube at normal temperature to have a temperature of 25 to 40° C., then
heating the carbon nano tube to a temperature of 300 to 600° C. and keeping the carbon nano tube at the temperature for 2 to 4 hours, and then
injecting inert gas thereto to cool the carbon nano tube to normal temperature.

6. The method for manufacturing a separation membrane for seawater desalination according to claim 4,
wherein when the carbon nano tube with an open terminal is coated in Step 2), the dopamine is used in amount of 1,000 parts by weight, based on 100 parts by weight of the carbon nano tube with an open terminal.

7. The method for manufacturing a separation membrane for seawater desalination according to claim 4,
wherein the amine solution contains at least one amine selected from the group consisting of ortho-phenylene diamine, meta-phenylene diamine, para-phenylene diamine, piperazine, ethylene diamine, cadaverine, and their mixtures.
